(19) United States
(12) Patent Application Publication
(10) Pub. No.: US 2018/0062936 A1
(43) Pub. Date: Mar. 1, 2018

(54) Display of Server Capabilities

(71) Applicant: HEWLETT-PACKARD DEVELOPMENT COMPANY, L.P., HOUSTON, TX (US)

(72) Inventor: DARYL T POE, FORT COLLINS, CO (US)

(21) Appl. No.: 15/557,933

(22) PCT Filed: May 15, 2015
(86) PCT No.: PCT/US15/31205

§ 371 Date: Sep. 13, 2017

(51) Int. Cl. H04L 12/24

(52) U.S. Cl. CPC H04L 41/14; H04L 69/24; H04L 41/22

(57) ABSTRACT

Examples disclosed herein relate to displaying server capabilities. Some examples disclosed herein may enable obtaining, by a client computing device, a set of server capabilities supported by a server computing device. A remote connection may be established between the server computing device and the client computing device. Some examples disclosed herein may enable triggering, by the client computing device, a display of the set of server capabilities via a user interface of the client computing device. A first server capability in the set of server capabilities that is supported by the client computing device may be displayed visually different from a second server capability in the set of server capabilities that is not supported by the client computing device.

### BACKGROUND

In a remote desktop environment a server runs a desktop session locally and provides the outputted graphics information to a remote client for display. In response, the client may output the graphics on an available display and subsequently process input from the user for transmission back to the server. This process continues, with the server transmitting the graphics stream and the client transmitting input events. In this manner, the client device may interact with a remote desktop processed by the server as if it were a local desktop processed by the client. Similarly, in a remote application environment, a software application running on a remote server may appear to the user as if it were running locally on the client.

### BRIEF DESCRIPTION OF THE DRAWINGS

The following detailed description references the drawings, wherein:

FIG. 1 is a block diagram depicting an example system for displaying server capabilities.

FIG. 2 is a block diagram depicting an example system or displaying server capabilities.

FIG. 3 is a block diagram depicting an example machine-readable storage medium comprising instructions executable by a processor for providing server capabilities.

FIG. 4 is a block diagram depicting an example machine-readable storage medium comprising instructions executable by a processor for displaying server capabilities.

FIG. 5 is a flow diagram depicting an example method for displaying server capabilities.

FIG. 6 is a flow diagram depicting an example method for displaying server capabilities.

FIG. 7 is a flow diagram depicting an example method for displaying server capabilities.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications,, adaptations, and other implementations are possible. Accordingly, the following detailed description does not limit the disclosed examples. Instead, the proper scope of the disclosed examples may be defined by the appended claims.

Remote desktop environments enable a user to interact with a remote desktop processed by a server (also referred herein as a “server computing device”) as if it were a local desktop of a client (also referred herein as a “client computing device). Similarly, in remote application environments, a software application running on a remote server may appear to the user as if it were running locally on the client.

A remote connection (e.g., connection to a remote desktop and/or to a remote application) may be established using at least one of various remote protocols. For example, an administrator or other entity may be able to choose between the Microsoft. Remote Desktop Protocol (RDP), VMware View, Citrix Independent Computing Architecture (ICA), or a number of other remote protocols.

In many of such remote protocols, a set of capabilities may be exchanged between a server and a client. The set of capabilities may comprise an audio input, an audio output, a printer redirection, a hardware bus redirection, security protocols, multimedia compression algorithms, clipboard functions, or a combination thereof. For example, the server may provide a set of server capabilities that are supported by the server and/or receive a set of client capabilities that are supported by the client. The exchange of these capabilities may occur during a capabilities negotiation phase (e.g., at the beginning of the remote connection session and/or immediately after the remote connection is established). Based on the exchanged information, the minimum set of capabilities supported by both of the server and the client may be identified and/or used for the remote connection session. However, although a capability can be supported by both the server and the client, that capability may be disabled at the server and/or the client, making it unavailable for use during the remote connection session. Because information as to which capabilities are supported by the server and/or the client, which capabilities are enabled at the server and/or the client, and/or which capabilities are disabled at the server and/or the client is not readily available to the user, it may be challenging to diagnose the real cause of a missing capability.

Examples disclosed herein provide technical solutions to these technical challenges by providing a technique to display server capabilities. Some examples disclosed herein may enable obtaining, by a client computing device, a set of server capabilities supported by a server computing device. A remote connection may be established between the server computing device and the client computing device. Some examples disclosed herein may enable triggering, by the client computing device, a display of the set of server capabilities via a user interface of the client computing device. A first server capability in the set of server capabilities that is supported by the client computing device may be displayed visually different from a second server capability in the set of server capabilities that is not supported by the client computing device.

The terminology used herein is for the purpose of describing particular embodiments only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of one or more of the associated listed items. It will also be, understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

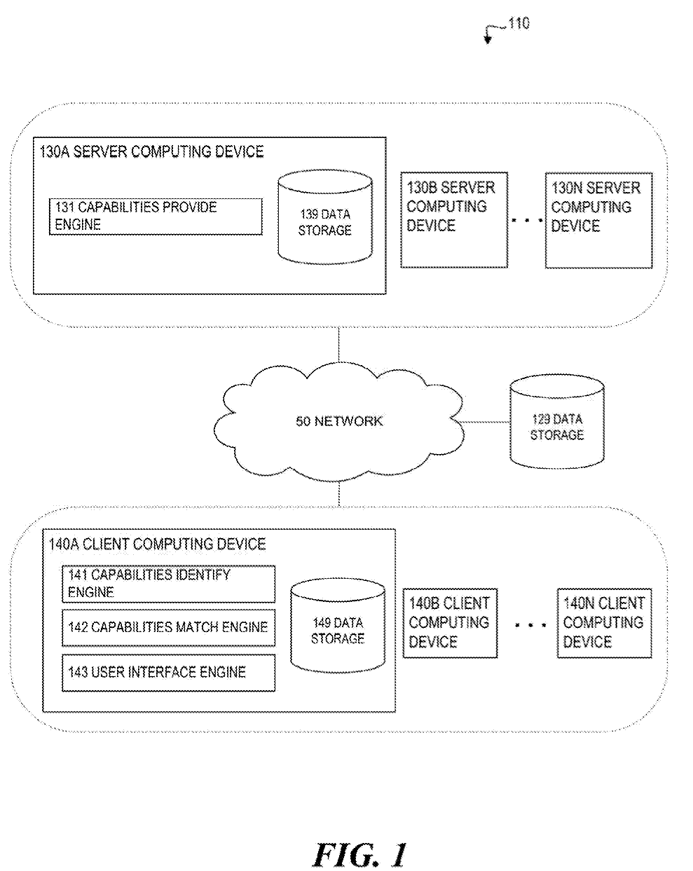

FIG. 1 is a block diagram depicting an example system for displaying server capabilities.

The various components may include client computing devices 140 (illustrated as 140A, 1408, . . . , 140N) and server computing devices 130 (illustrated as>server computing device 130A, 130B, . . . 130N). Each client computing device 140A, 140B, . . . , 140N may communicate requests to and/or receive responses from server computing device 130. Server computing device 130 may receive and/or respond to requests from client computing devices 140. Client computing devices 140 may include any type of computing device providing a user interface through which a user can interact with a software application. For example, client computing devices 140 may include a laptop computing device, a desktop computing device, an all-in-one computing device, a thin client, a workstation, a tablet computing device, a mobile phone, an electronic book reader, a network-enabled appliance such as a “Smart” television, and/or other electronic device suitable for execution of the functionality described below. While server computing device 130 is depicted as a single computing device, server computing device 130 may include any number of integrated or distributed computing devices.

The various components (e.g., components 129, 130, and 140) depicted in FIG. 1 may be coupled to at least one other component via a network 50. Network 50 may, comprise any infrastructure or combination of infrastructures that enable electronic communication between the components. For example, network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, system 100 and the various components described herein may be implemented in hardware and/or programming that configures hardware. Furthermore, in FIG. 1 and other Figures described herein, different numbers of components or entities than depicted may be used.

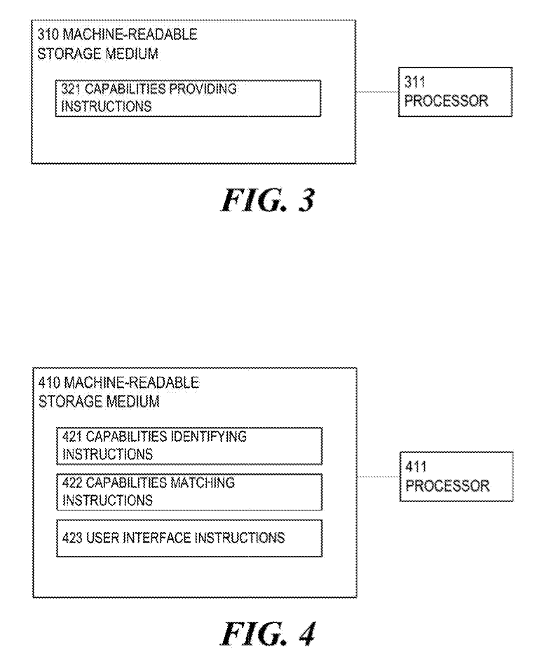

As detailed below, server computing device 130 may comprise a capabilities provide engine 131 and/or other engines. The term “engine”, as used herein, refers to a combination of hardware and programming that performs a designated function. As is illustrated respect to FIGS. 3-4, the hardware of each engine, for example, may include one or both of a processor and a machine-readable storage medium, while the programming is instructions or code stored on the machine-readable storage medium and executable by the processor to perform the designated function.

Capabilities provide engine 131 may provide a set of server capabilities supported by a server computing device (e.g., server computing device 130) to a client computing device (e.g., client computing device 140). Capabilities provide engine 131 may provide this set of server capabilities during a capabilities negotiation phase. The capabilities negotiation phase may occur after a remote connection is established between server computing device 130 and client computing device 140 (e.g., at the beginning of a remote connection session). In some instances, capabilities provide engine 131 may receive and/or obtain a set of client capabilities from client computing device 140 during the capabilities negotiation phase. The set of server (and/or client) capabilities may comprise an audio input, an audio output, a printer redirection, a hardware bus redirection, security protocols, multimedia compression algorithms, clipboard functions, and a combination thereof.

As discussed below with respect to user interface engine 143, the set of server capabilities may be displayed via a user interface of client computing device 140 such that a user may access and/or view the set of server capabilities that are supported by server computing device 130. The set of server capabilities may, for example, comprise a first server capability (e.g., an audio output) and a second server capability (e.g., clipboard functions). Assuming that the first server capability is also supported by client computing device 140 whereas the second server capability is not supported by client computing device 140, the first server capability may be displayed visually different from the second server capability in the user interface.

As used herein, a particular server capability may be said to be “visually different” from another server capability when different visual indicators are used to distinguish one from the other. A visual indicator may include not be limited to a visual icon and/or graphic (e.g., displayed adjacent to its corresponding capability), a color (e.g., a capability highlighted in a different color), and a font (e.g., a capability shown in a different font).

For example, a first visual indicator may indicate that a server capability is supported (or not supported) by client computing device 140. A second visual indicator may indicate that a server capability is enabled for disabled) at server computing device 130. A third visual indicator may indicate that a server capability is enabled (or disabled) at client computing device 140. A fourth visual indicator may indicate that a help guide is available for instructions on how to enable a server capability at server computing device 130 (or at client computing device 140).

In performing its functions, engine 131 may access data storage 129, data storage 139, and/or other suitable database(s). Data storage 129 and/or 139 may represent any memory accessible to system 110 that can be used to store and retrieve data.

As detailed below, client computing device 140 may comprise a capabilities identify engine 141, a capabilities match engine 142, a user interface engine 143, and/or other engines.

Capabilities identify engine 141 may receive, obtain, or otherwise identify a set of server capabilities supported by server computing device 130. The set of server capabilities may be provided by capabilities provide engine 131 as discussed above. In some implementations, capabilities identify engine 141 may identify the set of server capabilities during a capabilities negotiation phase. As discussed above, the capabilities negotiation phase may occur after a remote connection is established between server computing device 130 and client computing device 140 (e.g., at the beginning of a remote connection session). For example, capabilities identify engine 141 may identify data being exchanged between server computing device 130 and client computing device 140 during the capabilities negotiation phase. The data being exchanged may then be parsed by capabilities identify engine 141 to identify the set of server capabilities supported by server computing device 130.

Capabilities identify engine 141 may identify a set of client capabilities supported by client computing device 140 during the capabilities negotiation phase. In some instances, capabilities identify engine 141 may provide the set of client capabilities to server computing device 130 during the capabilities negotiation phase, The set of server (and/or client) capabilities may comprise an audio input, an audio output, a printer redirection, a hardware bus redirection, security protocols, multimedia compression algorithms, clipboard functions, and a combination thereof.

A capability of the set of server (and/or client) capabilities may be associated with an indication of whether the capability is supported (and/or not supported) by server computing device 130 and/or client computing device 140, an indication of whether the capability is enabled (and/or disabled) at server computing device 130 and/or client computing device 140, an indication of whether a help guide is available for enabling the capability, and/or other information.

The set of server and/or client capabilities and/or their associated information may be stored in a data storage (e.g., data storage 129, 139, and/or 149).

Capabilities match engine 142 may determine whether a particular server capability of the set of server capabilities matches at least one client capability of the set of client capabilities. In other words, this can determine whether the particular server capability that is supported by server computing device 130 is supported by client computing device 140 as well. For example, the server capability for hardware bus redirection may be compared to the set of client capabilities supported by client computing device 140. A matching client capability may be found if at least one client capability of the set of client capabilities is also directed to hardware bus redirection. In this way, capabilities match engine 142 may determine which server capabilities are supported by (and/or not supported by) client computing device 140.

In some implementations this determination of whether a particular server capability of the set of server capabilities matches at least one client capability of the set of client capabilities may be triggered at a user request. For example, a user may select the particular server capability from the set of capabilities being displayed via the user interface. Such an indication that the particular server capability is selected by the user via the user interface may be obtained by user interface engine 143 that is further discussed below. In response to this indication, capabilities match engine 142 may determine whether this selected server capability matches at least one client capability of the set of client capabilities.

User interface engine 143 may trigger a display of the set of server capabilities via a user interface of client computing device 140. In this way, a user may access and/or view the set of server capabilities that are supported by server computing device 130. In some implementations, all of the server capabilities supported by server computing device 130 may be displayed via the user interface. In other implementations, the server capabilities that are supported by both server computing device 130 and client computing device 140 may be displayed via the user interface. In these implementations, any server capabilities not supported by client computing device 140 may be excluded from the display.

In some implementations, information related to the set of server capabilities may be displayed along with the set of server capabilities. For example, user interface engine 143 may visually communicate an indication of whether a particular capability is supported (and/or not supported) by server computing device 130 and/or client computing device 140, an indication of whether the capability is enabled (and/or disabled) at server computing device 130 and/or client computing device 140, and/or an indication of whether a help guide is available for enabling the capability by using different visual indicators. A visual indicator may include not be limited to a visual icon and/or graphic (e.g., displayed adjacent to its corresponding capability), a color (e.g., a capability highlighted in a different color), and a font (e.g., a capability shown in a different font).

For example, a first visual indicator may indicate that a server capability is supported (or not supported) by client computing device 140. A second visual indicator may indicate that a server capability is enabled (or disabled) at server computing device 130. A third visual indicator may indicate that a server capability is enabled (or disabled) at client computing device 140. A fourth visual indicator may indicate that a help guide is available for instructions on how to enable a server capability at server computing device 130 (or at client computing device 140).

Consider this example: the set of server capabilities displayed may include a first server capability (e.g., audio output) that is also supported by client computing device 140 and a second server capability (e.g., clipboard functions) that is not supported by client computing device 140. In some implementations, user interface engine 143 may trigger the display of the first server capability such that the first server capability may be displayed visually different from the second server capability. As used herein, a particular server capability may be said to be “visually different” from another server capability when different visual indicators are used to distinguish one from the other.

In some implementations, user interface engine 143 may trigger the display of a help guide via the user interface where the help guide provides instructions on how to enable a particular server (and/or client) capability (e.g., that is currently disabled at server computing device 130 and/or client computing device 140) at its respective computing device. For example, the help guide may comprise textual, video, and/or audio content that explain to the user how to enable the particular capability.

In performing their respective functions, engines 141-143 may access data storage 129, data storage 149, and/or other suitable database(s). Data storage 129 and/or 149 may represent any memory accessible to system 110 that can be used to store and retrieve data.

Data storage 129 and/or other database may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. Data storages 129 and/or other database may include a database to organize and store data. The database may reside in a single or multiple physical device(s) and in a single or multiple physical location(s). The database may store a plurality of types of data and/or files and associated data or file description, administrative information, or any other data.

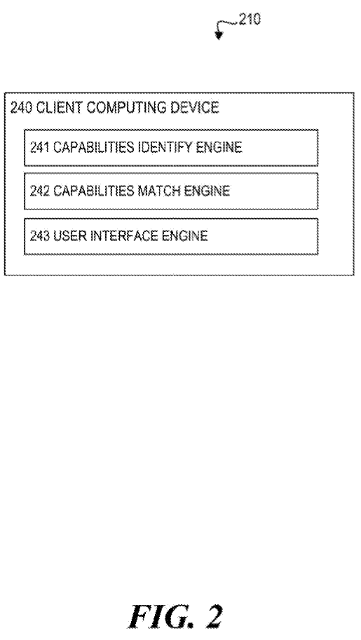

FIG. 2 is a block diagram depicting an example system 210 for displaying server capabilities. System 210 may comprise client computing device 240 comprising a capabilities identify engine 241, a capabilities match engine 242, a user interface engine 243, and/or other engines. Engines 241-243 represent engines 141-143, respectively.

FIG. 3 is a block diagram depicting an example machine-readable storage medium 310 comprising instructions executable by a processor for providing server capabilities.

In the foregoing discussion, engine 131 was described as combinations of hardware and programming. Engine 131 may be implemented in a number of fashions. Referring to FIG. 3, the programming may be processor executable instructions 321 stored on a machine-readable storage medium 310 and the hardware may include a processor 311 for executing those instructions. Thus, machine-readable storage medium 310 can be said to store program instructions or code that when executed by processor 311 implements engine 131 of FIG. 1.

In FIG. 3, the executable program instructions in machine-readable storage medium 310 are depicted as capabilities providing instructions 321. Instructions 321 represent program instructions that, when executed, cause processor 311 to implement engine 131.

FIG. 4 is a block diagram depicting an example machine-readable storage medium 410 comprising instructions executable by a processor for displaying server capabilities.

In the foregoing discussion, engines 141-143 were described as combinations of hardware and programming. Engines 141-143 may be implemented in a number of fashions. Referring to FIG. 4, the programming may be processor executable instructions 421-423 stored on a machine-readable storage medium 410 and the hardware may include a processor 411 for executing those instructions. Thus, machine-readable storage medium 410 can be said to store program instructions or code that when executed by processor 411 implements engines 141-143 of FIG. 1.

In FIG. 4, the executable program instructions in machine-readable storage medium 410 are depicted as capabilities identifying instructions 421, capabilities matching instructions 422, and user interface instructions 423. Instructions 421-423 represent program instructions that, when executed, cause processor 411 to implement engines 141-143, respectively.

Machine-readable storage medium 310 (or machine-readable storage medium 410) may be any electronic, magnetic, optical, or other physical storage device that contains or stores executable instructions. In some implementations, machine-readable storage medium 310 (or machine-readable storage medium 410) may be a non-transitory storage medium, where the term “non-transitory” does not encompass transitory propagating signals. Machine-readable storage medium 310 (or machine-readable storage medium 410) may be implemented in a single device or distributed across devices. Likewise, processor 311 (or processor 411) may represent any number of processors capable of executing instructions stored by machine-readable storage medium 310 (or machine-readable storage medium 410). Processor 311 (or processor 411 may be integrated in a single device or distributed across devices. Further, machine-readable storage medium 310 (or machine-readable, storage medium 410) may be fully or partially integrated in the same device as processor 311 (or processor 411) or it may be separate but accessible to that device and processor 311 (or processor 411).

In one example, the program instructions may be part of an installation package that when installed can be executed by processor 311 (or processor 411) to implement system 110. In this, case, machine-readable storage medium 310 (or machine-readable storage medium 410) may be a portable medium such as a floppy disk, CD, DVD, or flash drive or a memory maintained by a server from which the installation package can be downloaded and installed. In another example, the program instructions may be part of an application or applications already installed. Here, machine-readable storage medium 310 (or machine-readable storage medium 410) may include a hard, disk, optical disk, tapes, solid state drives, RAM, ROM, EEPROM, or the like.

Processor 311 may be at least one central processing unit (CPU), microprocessor, and/or other hardware device suitable for retrieval and execution of instructions stored in machine-readable storage medium 310. Processor 311 may fetch, decode, and execute program instructions 321, and/or other instructions. As an alternative or in addition to retrieving and executing instructions, processor 311 may include at least one electronic circuit comprising a number of electronic components for performing the functionality of at least one of instructions 321, and/or other instructions.

Processor 411 may be at least one central processing unit (CPU), microprocessor, and/or other hardware device suitable for retrieval and execution of instructions stored in machine-readable storage medium 410. Processor 411 may fetch, decode, and execute program instructions 421-423, and/or other instructions. As an alternative or in addition to retrieving and executing instructions, processor 411 may include at least one electronic circuit comprising a number of electronic components for performing the functionality of at least one of instructions 421-423, and/or other instructions.

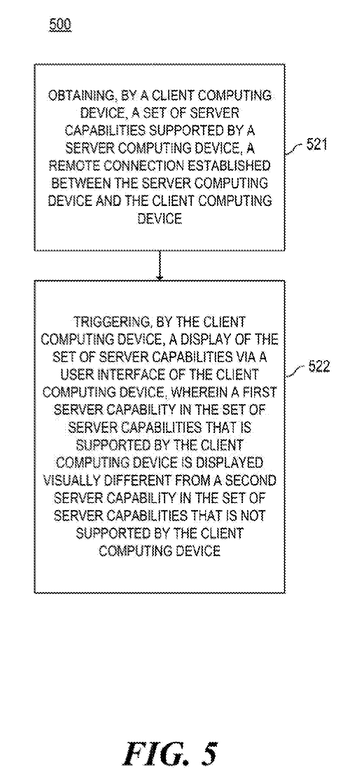

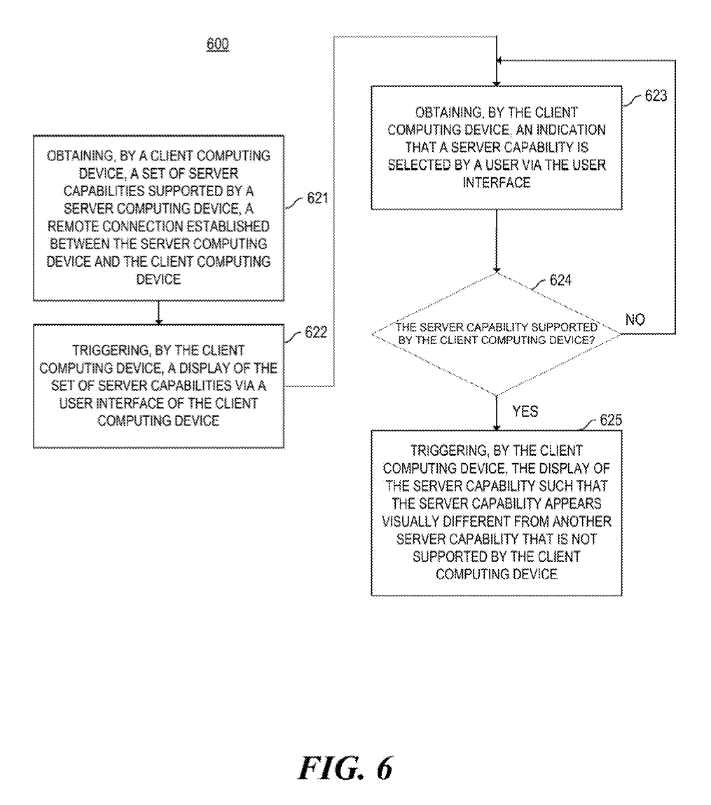

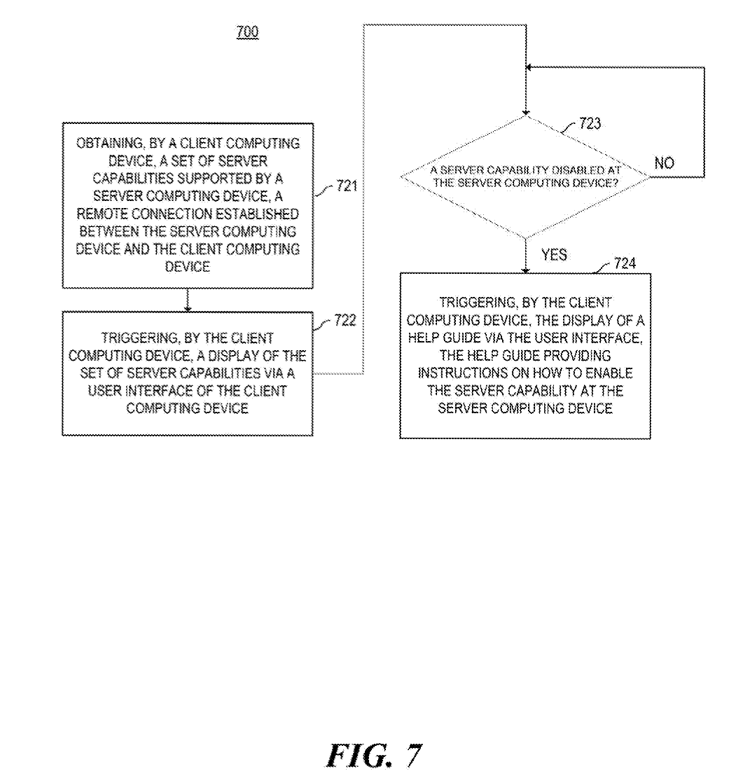

FIG. 5 is a flow diagram depicting an example method 500 for displaying server capabilities. The various processing blocks and/or data flows depicted in FIG. 5 (and in the other drawing figures such as FIGS. 6-7) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 500 as illustrated (and described in greater detail below) is meant to be an example and, as such, should not be viewed as limiting. Method 500 may be implemented in the form of executable instructions stored on a machine-readable storage medium, such as storage medium 310, and/or in the form of electronic circuitry.

In block 521, method 500 may include obtaining, by a client computing device, a set of server capabilities supported by a server computing device. A remote connection may be established between the server computing device and the client computing device. Referring back to FIG. 1, capabilities identify engine 141 may be responsible for implementing block 521.

In block 522, method 500 may include triggering, by the client computing device, a display of the set of server capabilities via a user interface of the client computing device, wherein a first server capability in the set of server capabilities that is supported by the client computing device is displayed visually different from a second server capability in the set of server capabilities that is not supported by the client computing device. Referring back to FIG. 1, user interface engine 143 may be responsible for implementing block 522.

FIG. 6 is a flow diagram depicting an example method 600 for displaying server capabilities. Method 600 as illustrated (and described in greater detail below) is meant be an example and, as such, should not be viewed as limiting. Method 600 may be implemented in the form of executable instructions stored on a machine-readable storage medium, such as storage medium 310, and/or in the form of electronic circuitry.

In block 621, method 600 may include obtaining, by a client computing device, a set of server capabilities supported by a server computing device. A remote connection may be established between the server computing device and the client computing, device. Referring back to FIG. 1, capabilities identify engine 141 may be responsible for implementing block 621.

In block 622, method 600 may include triggering, by the client computing device, a display of the set of server capabilities via a user interface of the client computing device. Referring back to FIG. 1, user interface engine 143 may be responsible for implementing block 622.

In block 623, method 600 may include obtaining, by the client computing device, an indication that a server capability is selected from the set of server capabilities by a user via the user interface. Referring back to FIG. 1, user interface engine 143 may be responsible for implementing block 623.

In response to the indication (e.g., obtained in block 623), method 600 may include, in block 624, determining whether the selected server capability is supported by the client computing device. Referring back to FIG. 1, capabilities match engine 142 may be responsible for implementing block 624.

If determined that the selected server capability is supported by the client computing device, method 600 may proceed to block 625. Otherwise, method 600 may return to block 623.

In block 625, method 600 may include triggering, by the client computing device, the display of the server capability such that the server capability appears visually different from another server capability that is not supported by the client computing device. Referring back to FIG. 1, user interface engine 143 may be responsible for implementing block 625.

FIG. 7 is a flow diagram depicting an example method 700 for displaying server capabilities. Method 700 as illustrated (and described in greater detail below) is meant be an example and, as such, should not be viewed as limiting. Method 700 may be implemented in the form of executable instructions stored on a machine-readable storage medium, such as storage medium 310, and/or in the form of electronic circuitry.

In block 721, method 700 may include obtaining, by a client computing device, a set of server capabilities supported by a server computing device. A remote connection may be established between the server computing device and the client computing device. Referring back to FIG. 1, capabilities identify engine 141 may be responsible for implementing block 721.

In block 722, method 700 may include triggering, by the client computing device, a display of the set of server capabilities via a user interface of the client computing device. Referring back to FIG. 1, user interface engine 143 may be responsible for implementing block 722.

In block 723, method 700 may include determining whether a server capability (e.g., displayed via the user interface in block 722) is disabled at the server computing device. Referring back to FIG. 1, capabilities identify engine 141 may be responsible for implementing block 723.

If determined that the server capability is disabled at the server computing device, method 700 may proceed to block 724. Otherwise, method 700 may return to block 723.

In block 724, method 700 may include triggering, by the client computing device, the display of a help guide via the user interface. The help guide may provide instructions on how to enable the server capability at the server computing device. Referring back to FIG. 1, user interface engine 143 may be responsible for implementing block 724.

The foregoing disclosure describes a number of example implementations for displaying server capabilities. The disclosed examples may include systems, devices, computer-readable storage media, and methods for displaying server capabilities. For purposes of explanation, certain examples are described with reference to the components illustrated in FIGS. 1-4. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 5-7 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for displaying server capabilities, the method comprising:
obtaining, by a client computing device, a set of server capabilities supported by a server computing device, a remote connection established between the server computing device and the client computing device; and
triggering, by the client computing device, a display of the set of server capabilities via a user interface of the client computing device, wherein a first server capability in the set of server capabilities that is supported by the client computing device is displayed visually different from a second server capability in the set of server capabilities that is not supported by the client computing device.

2. The method of claim 1, further comprising:
obtaining, by the client computing device, the set of server capabilities during a capabilities negotiation phase after the remote connection is established between the server computing device and the client computing device; and
providing, by the client computing device, a set of client capabilities supported by the client computing device to the server computing device during the capabilities negotiation phase.

3. The method of claim 2, wherein obtaining the set of server capabilities further comprises:
identifying, by the client computing device, data being exchanged between the client computing device and the server computing device during the capabilities negotiation phase;
parsing, by the client computing device, the data being exchanged to identify the set of server capabilities; and
triggering, by the client computing device, the display of the the set of server capabilities via the user interface of the client computing device.

4. The method of claim 1, wherein the set of server capabilities comprise an audio input, an audio output, a printer redirection, a hardware bus redirection, security protocols, multimedia compression algorithms, clipboard functions, or a combination thereof.

5. The method of claim 1, further comprising:
obtaining, by the client computing device, an indication that the first server capability is selected by a user via the user interface;
in response to the indication that the first server capability is selected by the user via the user interface, determining, by the client computing device, whether the first server capability is supported by the client computing device; and
in response to determining that the first server capability is supported by the client computing device, triggering, by the client computing device, the display of the first server capability such that the first server capability appears visually different from the second server capability that is not supported by the client computing device.

6. The method of claim 1, further comprising:
determining whether the first server capability is disabled at the server computing device; and
in response to determining that the first server capability is disabled at the server computing device, causing the first server capability to be enabled at the server computing device.

7. The method of claim 6, wherein causing the first server capability to be enabled at the server computing device comprises:
triggering the display of a help guide via the user interface, the help guide providing instructions on how to enable the first server capability at the server computing device.

8. A machine-readable storage medium comprising instructions executable by a processor of a server computing device for providing server capabilities, the machine-readable storage medium comprising:
instructions to provide a set of server capabilities supported by the server computing device to a client computing device during a capabilities negotiation phase after a remote connection is established between the server computing device and the client computing device,
wherein the set of server capabilities are displayed via a user interface of the client computing device, the set of server capabilities comprising a first server capability and a second server capability, and
wherein the first server capability that is supported by the client computing device is displayed visually different from the second server capability that is not supported by the client computing device.

9. The machine-readable storage medium of claim 8, wherein a first visual indicator is displayed via the user interface to indicate that the first server capability is supported by the client computing device.

10. The machine-readable storage medium of claim 8, wherein a second visual indicator is displayed via the user interface to indicate that the first server capability is disabled at the server computing device.

11. The machine-readable storage medium of claim 10, wherein a third visual indicator is displayed via the user interface to indicate that a help guide is available for instructing on how to enable the first server capability at the server computing device.

12. A system for displaying server capabilities comprising:
a client computing device comprising:
a capabilities identify engine to:
identify a set of server capabilities supported by a server computing device during a capabilities negotiation phase after a remote connection is established between the server computing device and the client computing device, and
identify a set of client capabilities supported by the client computing device during the capabilities negotiation phase;
a capabilities match engine to:
determine whether a first server capability of the set of server capabilities matches at least one client capability of the set of client capabilities; and
a user interface engine to:
trigger a display of the set of server capabilities via a user interface of the client computing device, and
in response to determining that the first server capability matches at least one client capability of the set of client capabilities, trigger the display of the first server capability such that the first server capability appears visually different from a second server capability in the set of server capabilities that does not match at least one client capability of the set of client capabilities.

13. The system of claim 12, further comprising:
the user interface engine to:
obtain an indication that the first server capability is selected by a user via the user interface; and
the capabilities match engine to:
in response to the indication that the first server capability is selected by the user via the user interface, determine whether the first server capability matches at least one client capability of the set of client capabilities.

14. The system of claim 12, further comprising:
the capabilities identify engine to:
determine whether the first server capability is disabled at the server computing device; and
the user interface engine to:
in response to determining that the first server capability is disabled at the server computing device, trigger the display of a first help guide via the user interface, the first help guide providing a first set of instructions on how to enable the first server capability at the server computing device.

15. The system of claim 14, further comprising
the capabilities identify engine to:
determine whether the at least one client capability that matches the first server capability is disabled at the client computing device; and
the user interlace engine to:
in response to determining that the at least one client capability is disabled, trigger the display of a second help guide via the user interface, the second help guide providing a second set of instructions on how to enable the at least one client capability at the client computing device.
